(19) United States
(12) Patent Application Publication
(10) Pub. No.: US 2025/0100917 A1
(43) Pub. Date: Mar. 27, 2025

(54) TREATMENT METHOD FOR WASTE WATER

(71) Applicant: YUH SHAN ENVIRONMENTAL ENGINEERING CO., LTD., Kaohsiung City (TW)

(72) Inventors: Kuan-Hung WU, Kaohsiung City (TW); Wen-Hsien TSAI, Kaohsiung City (TW); Yi-Kuo CHANG, Kaohsiung City (TW); Yuan-Hung LIU, Kaohsiung City (TW); Yu-Chi CHANG, Kaohsiung City (TW)

(21) Appl. No.: 18/890,787

(22) Filed: Sep. 20, 2024

(30) Foreign Application Priority Data
Sep. 22, 2023 (TW) 112136211

(51) Int. Cl. C02F 1/66; C02F 1/00; C02F 1/72; C02F 1/78; C02F 101/38

(52) U.S. Cl. CPC C02F 1/66; C02F 1/008; C02F 1/722; C02F 1/78; C02F 2101/38; C02F 2209/02; C02F 2209/06

(57) ABSTRACT

A treatment method for waste water is provided. The method includes providing the waste water. The waste water includes monoethanolamine, and COD of the wastewater is in a range between 5000 mg/L and 30000 mg/L. The method further includes adjusting pH value of the wastewater to be not smaller than 11.5; transferring the wastewater to a tank, and controlling a temperature of the tank to 20° C. to 32° C.; and adding hydrogen peroxide solution and ozone into the tank, thereby obtaining degraded waste water. By controlling treatment condition of the waste water, the waste water with the monoethanolamine and high COD can be degraded by using the hydrogen peroxide solution and the ozone.

### RELATED APPLICATION

This application claims priority to Taiwan Application Serial Number 112136211, filed Sep. 22, 2023, which is herein incorporated by reference.

### BACKGROUND

### Field of Invention

The present invention relates to a treatment method for waste water. More particularly, the present invention relates to a treatment method for waste water including monoethanolamine.

### Description of Related Art

A semiconductor manufacturing industry and an element, such as optical electronic material, manufacturing industry use photoresist in a photolithography process, thereby needing to perform a stripping process. The stripping process includes a wet stripping method, which uses an organic solution to solute and to remove a photoresist material. The common photoresist in industry includes main component such as monoethanolamine (MEA), dimethylsulfoxide (DMSO), 1-methyl-2-pyrrolidinone (NMP), butyldiglycol (BDG), tetramethylammonium hydroxide (TMAH), and etc.

The monoethanolamine, which has pH value of about 12.6, is one of the important components of the stripper. The monoethanolamine (C₂H₇NO) is a kind of primary amine organic compounds, and it has hygroscopicity, toxicity, combustibility and corrosivity. The monoethanolamine is a transparent viscous liquid at room temperature and room pressure and has ammoniacal odor. The monoethanolamine can be decomposed to ammonia and acetaldehyde under the action of aerobic organisms.

However, the waste water with the stripper produced by high-tech factory has chemical oxygen demand (COD) above 5000 mg/L, such as 12000 mg/L to 30000 mg/L. The waste water with such concentration cannot achieve degradation of the monoethanolamine effectively by using biological treatment. Moreover, traditional method usually can only degrade the monoethanolamine to acidic substances, such that pH value would decrease continuously, and thus, degradability would decrease accordingly.

Therefore, it is needed to provide a treatment method for waste water including monoethanolamine to effectively degrade the waste water with great COD by controlling condition of waste water treatment.

### SUMMARY

An aspect of the present invention provides a treatment method for waste water, which can effectively degrade the waste water with great COD by controlling condition of waste water treatment.

According to the aspect of the present invention, providing a treatment method for waste water. The method includes providing the waste water. The wastewater includes monoethanolamine, and chemical oxygen demand (COD) of the waste water is in a range between 5000 mg/L and 30000 mg/L. The method further includes adjusting pH value of the waste water to be not smaller than 11.5; transferring the waste water to a tank, and controlling a temperature of the tank in a range of 20° C. to 32° C.; and adding hydrogen peroxide solution and ozone into the tank, thereby obtaining degraded waste water.

According to an embodiment of the present invention, an adding rate of the ozone is in a range of 3 g/L-hr to 6 g/L-hr.

According to an embodiment of the present invention, a concentration of the hydrogen peroxide solution is in a range of 35% to 45%, and an adding rate of the hydrogen peroxide solution is in a range of 2.5 mL/L-hr to 7.5 mL/L-hr.

According to an embodiment of the present invention, an adding rate of the hydrogen peroxide solution is in a range of 10 mg H₂O₂/L-hr to 30 mg H₂O₂/L-hr.

According to an embodiment of the present invention, an average particle size of bubbles of the ozone is in range of 50 nm to 360 μm.

According to an embodiment of the present invention, the ozone includes ultrafine bubbles and micro bubbles, an average particle size of the ultrafine bubbles is in a range between 50 nm and 185 nm, and an average particle size of the micro bubbles is in a range between 40 μm and 360 μm.

According to an embodiment of the present invention, a ratio of an adding amount of the hydrogen peroxide solution to an adding amount of the ozone is not greater than 0.01.

According to an embodiment of the present invention, a ratio of the COD of the degraded waste water to the COD of the waste water is not greater than 0.1.

According to an embodiment of the present invention, adjusting pH value of the waste water includes detecting the pH value of the waste water by a pH meter; and when the pH value of the waste water is smaller than 11.5, an alkaline solution is added to the waste water.

According to an embodiment of the present invention, a concentration of ammonia nitrogen of the degraded waste water is greater than a concentration of ammonia nitrogen of the waste water.

According to the aspect of the present invention, providing a treatment method for waste water. The method includes providing the waste water. The wastewater includes monoethanolamine, and COD of the waste water is in a range between 5000 mg/L and 30000 mg/L. The method further includes adding hydrogen peroxide solution and ozone into the tank to degrade the waste water, in which an adding rate of the ozone is in a range of 3 g/L-hr to 6 g/L-hr, and an adding rate of the hydrogen peroxide solution is in a range of 10 mg/L-hr to 30 mg/L-hr.

According to an embodiment of the present invention, the method further includes adjusting pH value of the waste water to greater than 11.5 before adding the hydrogen peroxide solution and the ozone into the tank.

According to an embodiment of the present invention, adjusting pH value of the waste water includes detecting the pH value of the waste water by a pH meter; and when the pH value of the waste water is smaller than or equal to 11.5, an alkaline solution is added to the waste water.

According to an embodiment of the present invention, the method further includes controlling a temperature of the tank in a range of 20° C. to 32° C. before adding the hydrogen peroxide solution and the ozone into the tank.

According to an embodiment of the present invention, a concentration of the hydrogen peroxide solution is in a range of 35% to 45%.

According to an embodiment of the present invention, the adding rate of the hydrogen peroxide solution is in a range of 2.5 mL/L-hr to 7.5 mL/L-hr.

According to an embodiment of the present invention, a ratio of an adding amount of the hydrogen peroxide solution to an adding amount of the ozone is not greater than 0.01.

According to an embodiment of the present invention, a concentration of ammonia nitrogen of the waste water is 10 mg/L to 30 mg/L.

According to an embodiment of the present invention, the ozone includes ultrafine bubbles and micro bubbles, an average particle size of the ultrafine bubbles is in a range between 50 nm and 185 nm, and an average particle size of the micro bubbles is in a range between 40 μm and 360 μm.

Application of the treatment method for waste water of the present invention, which can use hydrogen peroxide solution and ozone to degrade the waste water including monoethanolamine and with great COD by controlling condition of waste water treatment.

It is to be understood that both the foregoing general description and the following detailed description are by examples, and are intended to provide further explanation of the invention as claimed.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a diagram of a wastewater treatment equipment according to some embodiments of the present invention.

FIGS. 2A and 2B are particle size distribution diagrams of ultrafine bubbles and micro bubbles of ozone according to some embodiments of the present invention, respectively.

FIG. 3 illustrates a diagram of correlation between COD of waste water and degradation time according to an embodiment of the present invention.

FIG. 4 illustrates a diagram of correlation between COD of waste water and degradation time according to another embodiment of the present invention.

### DETAILED DESCRIPTION

As used herein, “around,” “about,” “approximately,” or “substantially” shall generally mean within 20 percent, or within 10 percent, or within 5 percent of a given value or range.

According to above, in order to effectively treat the industrial waste water including monoethanolamine and having great chemical oxygen demand (COD), the present invention provides a treatment method for waste water, which can use hydrogen peroxide solution and ozone to degrade the monoethanolamine by controlling condition of waste water treatment, thereby effectively reduce the COD of the waste water.

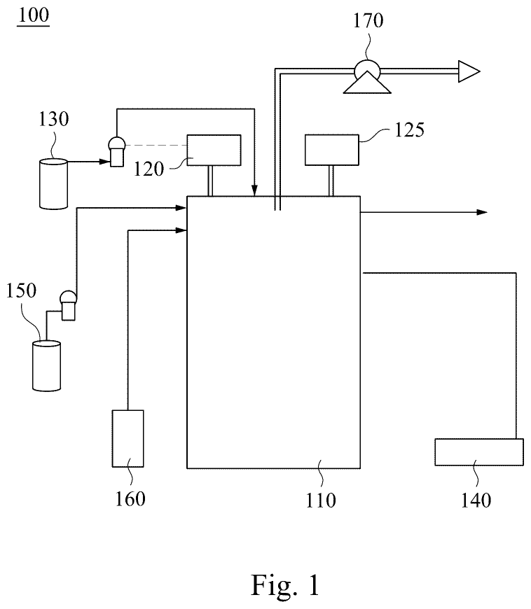

Referring to FIG. 1, FIG. 1 illustrates a diagram of a wastewater treatment equipment according to some embodiments of the present invention. The following describes the treatment method for waste water of the present invention, the waste water is provided to a tank 110 first. In some embodiment, the waste water includes monoethanolamine (MEA). In the aforementioned embodiment, a concentration of ammonia nitrogen (NH₃—N) of the waste water is 10 mg/L to 30 mg/L. It is understood that ammonia nitrogen means sum of compounded nitrogen existed as ammonia (NH₃) and ammonium ion (NH₄⁺). In some embodiments, the chemical oxygen demand (COD) of the waste water is about 5000 mg/L to about 30000 mg/L, preferably is about 12000 mg/L to about 30000 mg/L. Conventional method is not easy to treat the waste water with the aforementioned COD range, or the waste water should be diluted first to be capable of being degraded. However, the method of the present invention can be used to degrade the waste water directly without diluting the waste water first.

Subsequently, pH value of the waste water is adjusted to be not smaller than 11.5, preferably not smaller than 12. If the pH value of the waste water is smaller than 11.5, a removal rate of the ammonia nitrogen is not good in subsequent degradation process, resulting in bad degradation effect of the waste water. Moreover, since oxidation of the monoethanolamine may produce acidic products, the pH value of the waste water would continuously decrease, and the degradation effect would be worse. Thus, in order to maintain the degradation effect, the pH value of the waste water should be kept as not smaller than 11.5 during reaction process. In some embodiments, the waste water can be transferred to a tank first, and then the pH value of the waste water is adjusted.

In some embodiments, the above step of adjusting the pH value of the waste water includes following operations: the pH value of the waste water is detected by a pH controller 120; and when the pH value of the waste water is smaller than 11.5, an alkaline solution can be added to the waste water by using an alkaline chemical feeder 130.

In some embodiments, before adjusting the pH value of the waste water, coagulation-sedimentation of the waste water can be selectively performed, thereby removing particles such as inorganic sludge within the waste water. The coagulation-sedimentation can be performed by skills and methods known by those skilled in the art, so it is not described in detail herein.

Subsequently, the waste water can be transferred to another tank (such as ozone oxidation tank) or in the original tank 110, and a temperature of the tank 110 (i.e. reaction temperature) is controlled to about 20° C. to about 32° C. by using a temperature controller 125 and a heat exchanger 140, preferably is about 23° C. to about 32° C. When the temperature of the tank 110 is within the aforementioned range, the following degradation reaction can show suitable reaction rate, and hydroxyl (OH) radical used to perform degradation can exist abundantly, thereby effectively oxidizing monoethanolamine in the waste water.

Then, hydrogen peroxide solution is added into the tank 110 by using a chemical feeder 150 of the hydrogen peroxide solution, and ozone produced by a fine-bubble producer 160 is added into the tank to degrade the waste water. A chemical oxidation method combining ozone with hydrogen peroxide solution can produce abundant hydroxyl radicals, thereby oxidizing monoethanolamine in the waste water. There is no specific adding order of hydrogen peroxide solution and ozone; optionally, both of them can be added simultaneously, or be added in any order. In some embodiments, an adding rate of ozone is about 3 g/L-hr to about 6 g/L-hr. In some embodiments, an adding rate of hydrogen peroxide solution is about 10 mg H₂O₂/L-hr to about 30 mg H₂O₂/L-hr, in which the adding rate depends on the weight of the effective ingredient (i.e., the hydrogen peroxide or H₂O₂) in the hydrogen peroxide solution. In other embodiments, a concentration of the hydrogen peroxide solution is about 35% to about 45%, and an adding rate of the hydrogen peroxide solution is about 2.5 ml/L-hr to about 7.5 ml/L-hr. The adding rate of ozone and hydrogen peroxide solution are both controlled in the aforementioned range, thereby effectively oxidizing monoethanolamine in the waste water and reducing the COD of the waste water.

In some embodiments, a ratio of an adding amount of the hydrogen peroxide solution to an adding amount of the ozone is not greater than 0.01. When the ratio of the adding amount of the hydrogen peroxide solution to the adding amount of the ozone is controlled not greater than 0.01, the usage of the hydrogen peroxide solution can be saved to reduce manufacturing cost, while it still shows great degradation effect on the waste water. In a conventional treatment method for the waste water by using hydrogen peroxide solution and ozone, a large amount of hydrogen peroxide solution is usually used; thus, the manufacturing cost is higher.

In some embodiments, the adding ozone has an average particle size of about 50 nm to 360 μm. In some embodiments, the ozone produced by the fine-bubble producer 160 includes ultrafine bubbles and micro bubbles, an average particle size of the ultrafine bubbles is in a range between 50 nm and 185 nm, and an average particle size of the micro bubbles is in a range between 40 μm and 360 μm. The ozone as the ultrafine bubbles and the micro bubbles can form free radical with strong oxidizing power, thereby helping oxidize and decompose the monoethanolamine in the waste water.

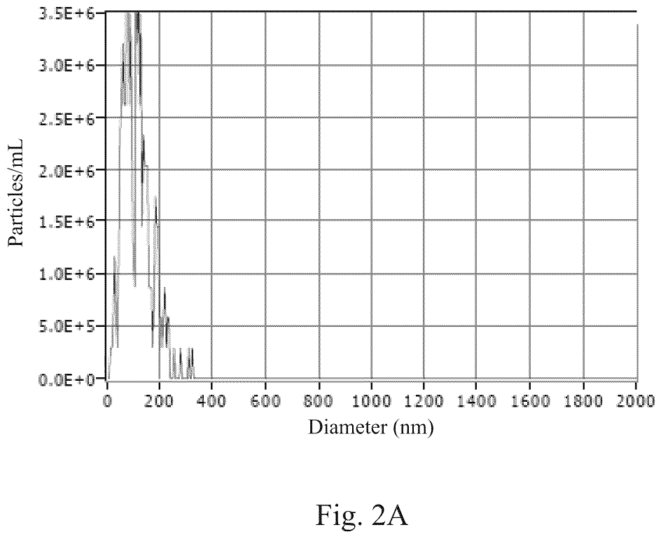

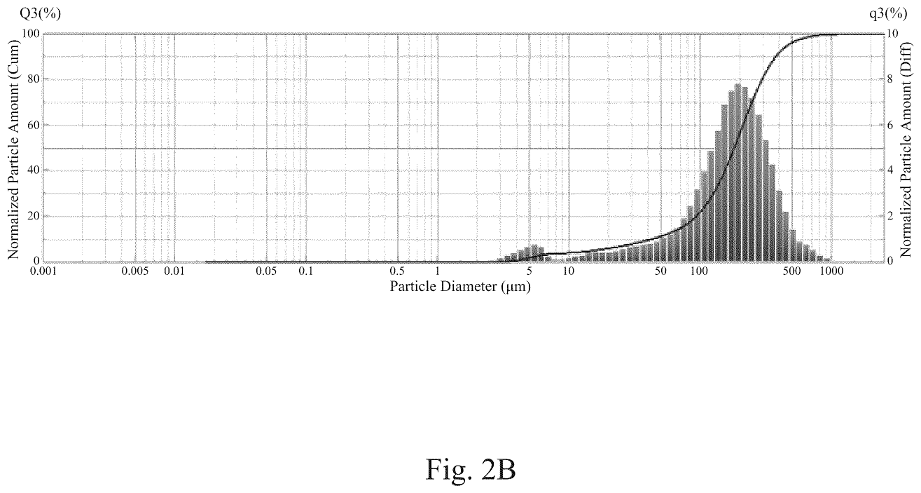

Referring to FIGS. 2A and 2B, FIGS. 2A and 2B were particle size distribution diagrams of ultrafine bubbles and micro bubbles of ozone according to some embodiments of the present invention, respectively. FIG. 2A was the particle size distribution diagram of the ultrafine bubbles of the ozone analyzed by using nanoparticle tracking analysis (NTA) (Manufacturer: ZETA-VIEW). FIG. 2A showed that the ultrafine bubbles of the ozone have d10 of 49.4 nm, d50 of 105.6 nm, d90 of 185.1 nm and the average particles size of 112.0 nm. It is noted that d10, d50 and d90 refer to there are 10%, 50% and 90% of the ultrafine bubbles have diameters smaller than such size.

FIG. 2B was the particle size distribution diagram of the micro bubbles of the ozone analyzed by using laser reflection/diffraction particle size analyzer SALD-2300 (Manufacturer: SHIMADZU), in which a vertical axis on the left side represented normalized cumulative percentage of particle amounts, while a vertical axis on the right side represented normalized percentage of particles amounts. FIG. 2B showed that the micro bubbles of the ozone have d10 of 40.346 μm, d50 of 177.376 μm, d90 of 368.277 μm and the average particles size of 142.396 μm.

In some embodiments, by controlling the above treating condition for the waste water, a ratio of the COD of the degraded waste water to the COD of the waste water before treatment is not greater than 0.1. In addition, the concentration of ammonia nitrogen of the degraded waste water would rise because the monoethanolamine in the waste water can be directly oxidized and decomposed to ammonia and carbon dioxide under the above condition, as shown in following reaction formula (1). The ammonia produced by degradation can be pumped out of the tank 110 by a pump 170. In the conventional method, the monoethanolamine may only be oxidized to glycine, so the pH value of the waste water would keep decreasing during degradation process; thus, the degradation effect is not good. Comparatively, the monoethanolamine is decomposed to ammonia and carbon dioxide, thereby being removed more easily.

2C₂H₇NO+5O₂→4CO₂₊2NH₃₊4H₂O (1)

The following Embodiments are provided to better elucidate the practice of the present invention and should not be interpreted in anyway as to limit the scope of same. Those skilled in the art will recognize that various modifications may be made while not departing from the spirit and scope of the invention. All publication and patent applications mentioned in the specification are indicative of the level of those skilled in the art to which this invention pertains.

### Example 1

Example 1 was performed a degradation treatment on waste water including monoethanolamine with COD of 11040 mg/L in 4 L. First, pH value of the waste water was adjusted to 12, and temperature of a reaction tank was controlled in a range between 23° C. and 28° C. after the waste water was transferred to the ozone oxidizing tank. Subsequently, ozone was added with a flow rate of 10 L/min (liter per minute, lpm) and an adding rate of 30 mg/L, and hydrogen peroxide solution with a concentration of 45% was added in 1 ml per 3 minutes. During degradation, the pH value of the reaction tank was kept at 12. The waste water was taken samples every hour, and the COD and a concentration of ammonia nitrogen of the waste water were detected. The detected results were shown in Table 1.

TABLE 1

| degradation time (hr) | COD (mg/L) | NH₃-N (mg/L) |
|---|---|---|
| 0 | 11040 | 27.41 |
| 1 | 6818 | 258.1 |
| 2 | 3500 | 234.7 |
| 3 | 1722 | 234.7 |
| 4 | 1000 | 180.1 |

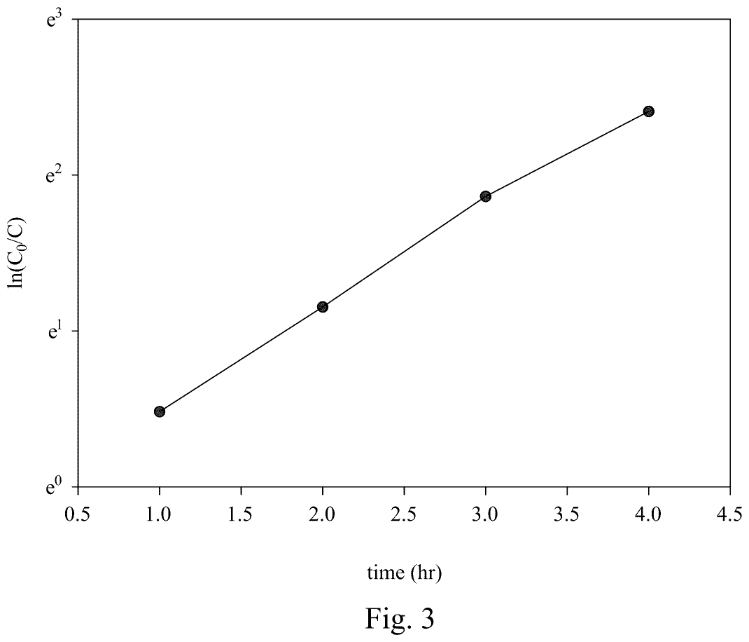

In addition, FIG. 3 illustrated a diagram of correlation between COD of waste water and degradation time according to an embodiment of the present invention, in which the horizontal axis was represented by the degradation time (hr), the vertical axis was represented by COD [In(C₀/C)], Co referred to the original COD of the waste water, C referred to the COD of the waste water after specific degradation time. According to variation of the COD with the degradation time, as shown in FIG. 3, it showed that decomposition reaction of the waste water with monoethanolamine was a first-order reaction with reaction rate constant of 0.5987 hr⁻¹.

### Example 2

Example 2 was performed under similar experimental condition as Example 1, while only difference was Example 2 had the waste water with COD of 27080 mg/L. The detected results of the COD and the concentration of ammonia nitrogen of the waste water every hour were shown in Table 2.

TABLE 2

| degradation time (hr) | COD (mg/L) | NH₃-N (mg/L) |
|---|---|---|
| 0 | 27080 | 12 |
| 1 | 13730 | 21.5 |
| 2 | 5243 | 56 |
| 3 | 2555 | 106 |

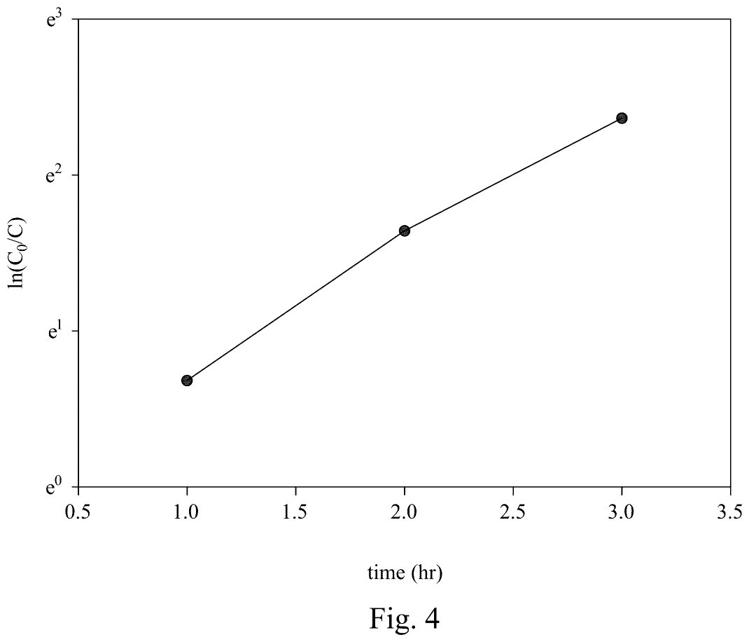

In addition, FIG. 4 illustrated a diagram of correlation between COD of waste water and degradation time according to another embodiment of the present invention, in which the horizontal axis was represented by the degradation time (hr), the vertical axis was represented by COD [In(C₀/C)], Co referred to the original COD of the waste water, C referred to the COD of the waste water after specific degradation time. Similar to Example 1, according to variation of the COD with the degradation time, as shown in FIG. 4, it showed that decomposition reaction of the waste water with monoethanolamine was a first-order reaction with reaction rate constant of 0.7889 hr⁻¹.

### Comparative Examples 1 and 2

Comparative examples 1 and 2 were performed under similar experimental condition as Example 1, while only differences were comparative examples 1 and 2 had the waste water amounts of 1 L; the COD of the waste water was 10878 mg/L; and the adding rate of ozone was 4.5 g/L-hr. Additionally, comparative example 1 did not control the reaction temperature, while comparative example 2 controlled the temperature of the reaction tank in a range between 23° C. and 27° C. without controlling the pH value. The detection results of the COD and the concentration of ammonia nitrogen of the waste water every hour of comparative example 1 were shown in Table 3, while the detection results of the pH value, the COD and the concentration of ammonia nitrogen of the waste water every hour of comparative example 2 were shown in Table 4.

TABLE 3

| degradation time (hr) | COD (mg/L) | NH₃-N (mg/L) |
|---|---|---|
| 0 | 10878 | 21.46 |
| 1 | 12232 | 10.59 |
| 2 | 10350 | 10.36 |
| 3 | 10480 | 10.79 |
| 4 | 10190 | 10.82 |

TABLE 4

| degradation time (hr) | pH value | COD (mg/L) | NH₃-N (mg/L) |
|---|---|---|---|
| 0 | 12 | 10878 | 21.46 |
| 1 | 11.1 | 9200 | 30.59 |
| 2 | 9.6 | 9850 | 16.25 |
| 3 | 8.2 | 9880 | 14.81 |
| 4 | 7.3 | 9990 | 15.63 |

According to above results of Examples, the COD of the waste water could be indeed decreased continuously while performing degradation for the waste water including monoethanolamine by controlling the pH value and the reaction temperature of the waste water, as well as adding hydrogen peroxide solution and ozone. Moreover, the monoethanolamine decomposed to NH₃ could be observed in the increasing concentration of the ammonia nitrogen. In addition, the reaction rate constant of Example 2 was greater than the reaction rate constant of Example 1. Therefore, the method could effectively perform degradation to the waste water with great COD.

Additionally, according to the results of comparative example 1, which did not control the reaction temperature, it showed that the COD of the waste water was not reduced, and comparative example 1 should add alkaline solution to keep the pH value at 12 unceasingly. Therefore, the monoethanolamine of comparative example 1 could only be oxidized to glycine. According to the results of comparative example 2, which did not control the pH value, the pH value was continuously decreased as the reaction was performed, and there was significant degradation of the waste water occurring at the first hour, while the COD of the waste water even continued upward trend in the following process.

Accordingly, the present invention can use hydrogen peroxide solution and ozone to oxidize and decompose the monoethanolamine of the waste water to ammonia and carbon dioxide, which are removable more easily by controlling condition of waste water treatment, thereby effectively degrading the waste water with great COD.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A treatment method for waste water, comprising:
providing the waste water, wherein the waste water comprises monoethanolamine, and chemical oxygen demand (COD) of the waste water is in a range between 5000 mg/L and 30000 mg/L;
adjusting pH value of the waste water to be not smaller than 11.5;
transferring the waste water to a tank, and controlling a temperature of the tank in a range of 20° C. to 32° C.; and
adding hydrogen peroxide solution and ozone into the tank, thereby obtaining degraded waste water.

2. The treatment method for the waste water of claim 1, wherein an adding rate of the ozone is in a range of 3 g/L-hr to 6 g/L-hr.

3. The treatment method for the waste water of claim 1, wherein a concentration of the hydrogen peroxide solution is in a range of 35% to 45%, and an adding rate of the hydrogen peroxide solution is in a range of 2.5 mL/L-hr to 7.5 mL/L-hr.

4. The treatment method for the waste water of claim 1, wherein an adding rate of the hydrogen peroxide solution is in a range of 10 mg H₂O₂/L-hr to 30 mg H₂O₂/L-hr.

5. The treatment method for the waste water of claim 1, wherein an average particle size of bubbles of the ozone is in a range of 50 nm to 360 μm.

6. The treatment method for the waste water of claim 1, wherein the ozone comprises ultrafine bubbles and micro bubbles, an average particle size of the ultrafine bubbles is in a range between 50 nm and 185 nm, and an average particle size of the micro bubbles is in a range between 40 μm and 360 μm.

7. The treatment method for the waste water of claim 1, wherein a ratio of an adding amount of the hydrogen peroxide solution to an adding amount of the ozone is not greater than 0.01.

8. The treatment method for the waste water of claim 1, wherein a ratio of the COD of the degraded waste water to the COD of the waste water is not greater than 0.1.

9. The treatment method for the waste water of claim 1, wherein adjusting the pH value of the waste water comprises:
detecting the pH value of the waste water by a pH controller; and
when the pH value of the waste water is smaller than 11.5, adding an alkaline solution to the waste water.

10. The treatment method for the waste water of claim 1, wherein a concentration of ammonia nitrogen of the degraded waste water is greater than a concentration of ammonia nitrogen of the waste water.

11. A treatment method for waste water, comprising:
providing the waste water into a tank, wherein the waste water comprises monoethanolamine, and COD of the waste water is in a range between 5000 mg/L and 30000 mg/L; and
adding hydrogen peroxide solution and ozone into the tank to degrade the waste water, wherein an adding rate of the ozone is in a range of 3 g/L-hr to 6 g/L-hr, and an adding rate of the hydrogen peroxide solution is in a range of 10 mg/L-hr to 30 mg/L-hr.

12. The treatment method for the waste water of claim 11, further comprising:
adjusting pH value of the waste water to greater than 11.5 before adding the hydrogen peroxide solution and the ozone into the tank.

13. The treatment method for the waste water of claim 12, wherein adjusting the pH value of the waste water comprises:
detecting the pH value of the waste water by using a pH controller; and
when the pH value of the waste water is smaller than or equal to 11.5, adding an alkaline solution to the waste water.

14. The treatment method for the waste water of claim 11, further comprising:
controlling a temperature of the tank in a range of 20° C. to 32° C. before adding the hydrogen peroxide solution and the ozone into the tank.

15. The treatment method for the waste water of claim 11, wherein a concentration of the hydrogen peroxide solution is in a range of 35% to 45%.

16. The treatment method for the waste water of claim 15, wherein the adding rate of the hydrogen peroxide solution is in a range of 2.5 mL/L-hr to 7.5 mL/L-hr.

17. The treatment method for the waste water of claim 11, wherein a ratio of an adding amount of the hydrogen peroxide solution to an adding amount of the ozone is not greater than 0.01.

18. The treatment method for the waste water of claim 11, wherein a concentration of ammonia nitrogen of the waste water is 10 mg/L to 30 mg/L.

19. The treatment method for the waste water of claim 11, wherein the ozone comprises ultrafine bubbles and micro bubbles, an average particle size of the ultrafine bubbles is in a range between 50 nm and 185 nm, and an average particle size of the micro bubbles is in a range between 40 μm and 360 μm.
